(19) United States
(12) Patent Application Publication
(10) Pub. No.: US 2024/0321508 A1
(43) Pub. Date: Sep. 26, 2024

(54) COIL DEVICE

(71) Applicant: TDK CORPORATION, Tokyo (JP)

(72) Inventors: Tomoya TSUBAI, Tokyo (JP); Takashi Arasawa, Tokyo (JP); Kouyu Ohi, Yurihonjo-City (JP)

(73) Assignee: TDK CORPORATION, Tokyo (JP)

(21) Appl. No.: 18/418,986

(22) Filed: Jan. 22, 2024

(30) Foreign Application Priority Data
Jan. 24, 2023 (JP) 2023-008551
Mar. 20, 2023 (JP) 2023-044378

(51) Int. Cl. H01F 27/29; H01F 27/26; H01F 27/30

(52) U.S. Cl. CPC H01F 27/292; H01F 27/266; H01F 27/306

(57) ABSTRACT

A coil device comprises a first wire connected to a first terminal; a second wire connected to a second terminal; a terminal block anchoring the first terminal and the second terminal; a bobbin including a first cylindrical portion wound around with the first wire and extending along a first axis, a second cylindrical portion wound around with the second wire and extending along the first axis, and a flange portion connecting the first cylindrical portion and the second cylindrical portion; and a core accommodated in the bobbin. The terminal block at least partly covers the flange portion of the bobbin.

### TECHNICAL FIELD

The present invention relates to a coil device.

### BACKGROUND

As a coil device applicable to uses involving large currents, suggested is a common mode choke coil described in Patent Document 1.

Disposing a bobbin between a core and a wire of the common mode choke coil of Patent Document 1 enables the common mode choke coil to be used for uses involving large currents. Unfortunately, demand of a coil device that is both applicable to uses involving high voltages and surface-mountable has been growing. A coil device such as that of Patent Document 1 does not sufficiently support recent uses involving high voltages and is difficult to be surface-mounted.
Patent Document 1: JP Utility Model Application Laid Open No. H7-7123

### SUMMARY

The present invention is achieved in view of such circumstances. It is an object of the invention to provide a coil device that is both applicable to uses involving high voltages and surface-mountable.

To achieve the above object, a coil device according to the present invention comprises: a first wire connected to a first terminal;
a second wire connected to a second terminal;
a terminal block anchoring the first terminal and the second terminal;
a bobbin including a first cylindrical portion wound around with the first wire and extending along a first axis, a second cylindrical portion wound around with the second wire and extending along the first axis, and a flange portion connecting the first cylindrical portion and the second cylindrical portion; and
a core accommodated in the bobbin,
wherein the terminal block at least partly covers the flange portion of the bobbin.

In such a structure, the terminal block at least partly covers the flange portion. This makes it easy to enhance a creepage distance between the wires and the core, more effectively ensuring insulation for recently demanded uses involving high voltages. Also, as the terminals are anchored to the terminal block, the coil device is readily surface-mounted on a circuit board or the like.

The bobbin may comprise a first bobbin and a second bobbin; and the first bobbin and the second bobbin may be connected at a first abutting portion of the first cylindrical portion and a second abutting portion of the second cylindrical portion. Preferably, the first abutting portion is disposed at a location shifted along the first axis from a location of the second abutting portion.

Difference between the locations of the respective abutting portions of the cylindrical portions enables mitigation of influence of stress generated by deformation of the circuit board or the like where the coil device is mounted. This increases strength of the coil device itself and also increases strength of the coil device after being surface-mounted.

Preferably, the core comprises a first core and a second core; the first core and the second core comprise respective opposing surfaces opposing each other along the first axis; and
the opposing surfaces are disposed at a location shifted from the location of the first abutting portion and the location of the second abutting portion.

Difference between the locations of the opposing surfaces of the core and the abutting portions of the cylindrical portions further increases the strength of the coil device. The opposing surfaces of the first core and the second core may be in direct contact, or a gap may be provided therebetween.

The core may comprise a first wound portion accommodated in the first cylindrical portion, a second wound portion accommodated in the second cylindrical portion, and a connecting portion connecting the first wound portion and the second wound portion; and the connecting portion may comprise an inner end surface connected to respective proximal ends of the first wound portion and the second wound portion, an outer end surface opposite the inner end surface along the first axis, and a side surface connecting the inner end surface and the outer end surface. Preferably, the flange portion comprises a flange inner end wall covering the inner end surface and a flange side wall covering the side surface; and the terminal block comprises a terminal block outer end wall covering the outer end surface and a terminal block side wall covering the flange side wall.

In such a structure, as the connecting portion of the core is completely covered by the flange portion of the bobbin and the terminal block, insulation of the core is further improved. In particular, as the side surface of the connecting portion is dually covered by the flange side wall and the terminal block side wall, a creepage distance between the terminals and the connecting portion is further improved.

The first terminal and the second terminal may each comprise a terminal main piece anchored to the terminal block outer end wall and a base piece disposed over a top surface of the terminal block side wall; and the base piece may be disposed with a predetermined space from the top surface. The first terminal and the second terminal may each comprise a mounting piece disposed with a predetermined space from a bottom surface of the terminal block side wall. Such a structure further improves the creepage distance between the terminals and the connecting portion.

The flange inner end wall may comprise a flange partition portion between the first cylindrical portion and the second cylindrical portion so that the flange partition portion enhances a creepage distance between the first wire and the second wire. The terminal block may comprise a terminal block uneven portion between the first terminal and the second terminal so that the terminal block uneven portion enhances a creepage distance between the first terminal and the second terminal.

The coil device may further comprise a cover attached to the terminal block so as to cover the first wire and the second wire from above.

The cover can protect the terminals and the wires and prevent electrical leakage from the terminals and the wires to other parts. Also, suctioning of a flat surface of the cover using a suction nozzle or the like enables easy transport of the coil device.

The flange portion may comprise a flange inner end wall covering the inner end surface; the flange inner end wall may comprise a flange partition portion between the first wire and the second wire; and the cover may comprise a cover partition portion fitted to the flange partition portion to isolate a coil portion of the first wire from a coil portion of the second wire.

Such a structure further improves insulation between the first wire and the second wire.

The terminal block may be made from a thermosetting resin; and the bobbin may be made from a thermoplastic resin.

Such a structure can effectively prevent cracks and chips at joints between the bobbin and the terminal block.

### BRIEF DESCRIPTION OF THE DRAWING(S)

FIG. 1 is an overall perspective view of a coil device according to an embodiment.

FIG. 2 is an exploded perspective view of the coil device according to FIG. 1.

FIG. 3 is a partial side elevational view of the coil device according to FIG. 1.

FIG. 4 is a partial plan view of the coil device according to FIG. 1.

FIG. 5 is a partial front elevational view of the coil device according to FIG. 1.

FIG. 6 is a sectional view along line VI-VI shown in FIG. 1.

FIG. 7 is a sectional view along line VII-VII shown in FIG. 1.

FIG. 8 is a sectional view along line VIII-VIII shown in FIG. 1.

FIG. 9 is a partial perspective view of the coil device shown in FIG. 1.

### DETAILED DESCRIPTION

An embodiment of the present invention is described below with reference to the drawings. Although the embodiment is described with reference to the drawings as necessary, the illustrated contents are only schematically and exemplarily shown for understanding of the present invention, and the appearance, dimensional ratios, etc. may be different from the actual ones. The present invention is specifically described below based on the embodiment but is not limited to the embodiment.

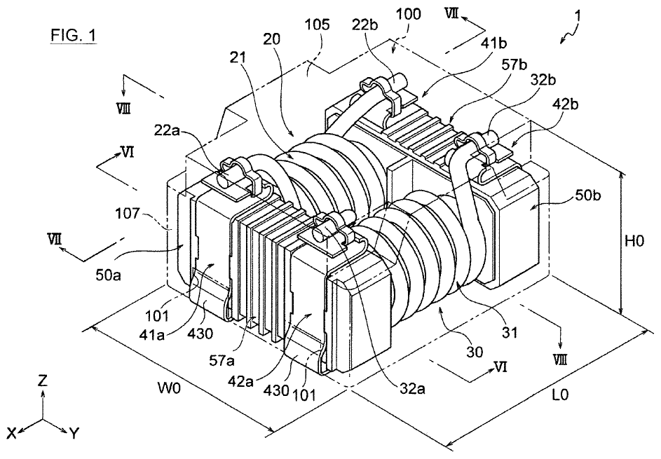

A coil device 1 according to the embodiment of the present invention illustrated in FIG. 1 is suitably used as, for example, a common mode filter or a common mode choke coil. As illustrated in FIG. 1, the coil device 1 according to the present embodiment has a substantially rectangular parallelepiped shape as a whole. The coil device 1 may have any external dimensions and can have, for example, a length L0 of 23.5 to 32.5 mm in the X-axis direction, a width W0 of 23.9 to 31.1 mm in the Y-axis direction, and a height H0 of 14.4 to 21.6 mm in the Z-axis direction, as illustrated in FIG. 1.

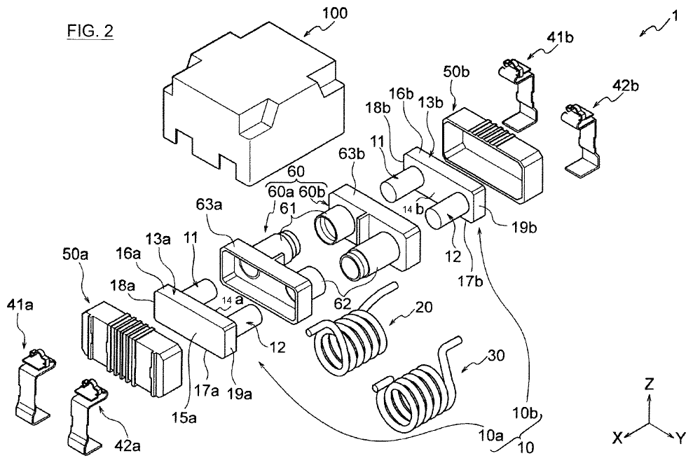

As illustrated in FIG. 2, the coil device 1 includes a core 10, a first wire 20, a second wire 30, a bobbin 60, terminal blocks 50a and 50b, first terminals 41a and 41b, and second terminals 42a and 42b. The coil device 1 also includes a cover 100.

The core 10 includes first wound portions 11 and second wound portions 12 extending in the X-axis direction, i.e., a first axis direction. The core 10 also includes connecting portions 13a and 13b each extending in the Y-axis direction, i.e., a second axis direction, and connecting ends of the corresponding first wound portion 11 and the corresponding second wound portion 12. The core 10 has a shape that is symmetrical in the X-axis and Y-axis directions but may partly lack symmetry. Note that, in the drawings, the X-axis, Y-axis, and Z-axis are substantially mutually perpendicular.

The core 10 contains a magnetic material. Examples of magnetic materials include ferrites, such as Ni—Zn based ferrites and Mn—Zn based ferrites, and metal magnetic materials, such as Fe—Ni alloys, Fe—Si alloys, Fe—Si—Cr alloys, Fe—Co alloys, Fe—Si—Al alloys, and amorphous iron. The core 10 may be produced by molding and sintering a powder of such magnetic materials. Alternatively, the core 10 may be molded by hardening such magnetic materials using resin. Examples of resin are not limited and include epoxy resin, phenol resin, polyester resin, polyurethane resin, polyimide resin, other synthetic resin, and other non-magnetic materials.

As illustrated in FIG. 2, the core 10 may be divided into a first core 10a including the connecting portion 13a and a second core 10b including the connecting portion 13b. The first core 10a and the second core 10b may have symmetrical U shapes. The connecting portion 13a includes an inner end surface 14a connected to respective proximal ends of the first wound portion 11 and the second wound portion 12 and an outer end surface 15a opposite the inner end surface 14a along the X-axis. The connecting portion 13a also includes side surfaces connecting the inner end surface 14a and the outer end surface 15a. The connecting portion 13a has a substantially rectangular parallelepiped shape, and the side surfaces include a first side surface 16a, a second side surface 17a, a third side surface 18a, and a fourth side surface 19a.

The connecting portion 13b has a shape identical to the connecting portion 13a. The connecting portion 13b includes an inner end surface 14b, an outer end surface 15b, and side surfaces connecting the inner end surface 14b and the outer end surface 15b. The connecting portion 13b has a substantially rectangular parallelepiped shape, and the side surfaces include a first side surface 16b, a second side surface 17b, a third side surface 18b, and a fourth side surface 19b.

As illustrated in FIG. 2, the first core 10a includes an opposing surface 11a of the first wound portion 11 and an opposing surface 12a of the second wound portion 12. The first wound portion 11 of the second core 10b includes an opposing surface 11b, which opposes the opposing surface 11a along the X-axis. The second wound portion 12 of the second core 10b includes an opposing surface 12b, which opposes the opposing surface 12a along the X-axis.

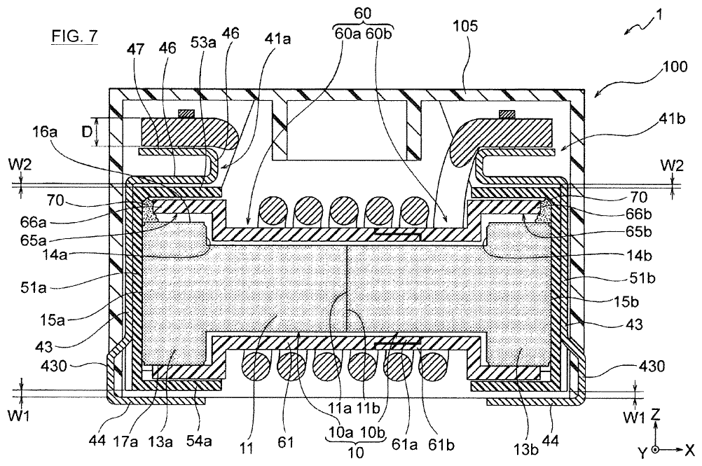

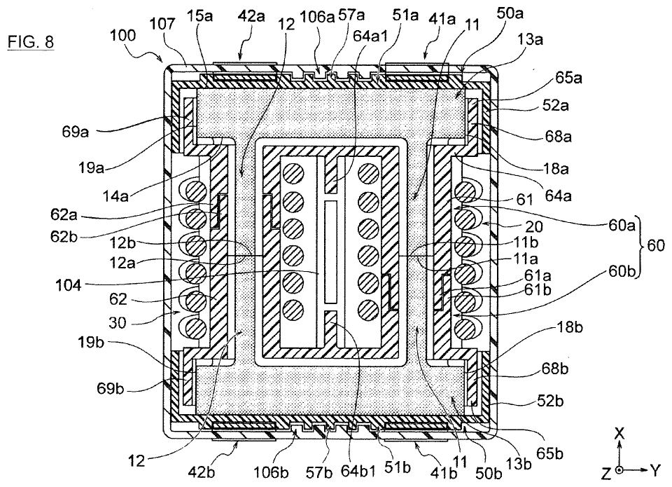

As illustrated in FIG. 8, the core 10 has a ring shape in which the opposing surface 11a of the first core 10a and the opposing surface 11b of the second core 10b as well as the opposing surface 12a of the first core 10a and the opposing surface 12b of the second core 10b are anchored using an adhesive. The opposing surfaces 11a and 11b as well as the opposing surfaces 12a and 12b may be in direct contact, but a gap may be provided between the opposing surfaces 11a and 11b as well as between the opposing surfaces 12a and 12b. The core 10 is accommodated in the bobbin 60 illustrated in FIG. 2. As illustrated in FIG. 7, the core 10 may be anchored to the bobbin 60 using an adhesive 70. The adhesive 70 is preferably electrically insulating.

As illustrated in FIG. 2, the bobbin 60 includes first cylindrical portions 61 wound around with the first wire 20 and extending along the X-axis, second cylindrical portions 62 wound around with second wire 30 and extending along the X-axis, and flange portions 63a and 63b each connecting the corresponding first cylindrical portion 61 and the corresponding second cylindrical portion 62.

The bobbin 60 is made from an insulating material. The insulating material is not limited, and any insulating material that is easily and thinly molded into the first and second cylindrical portions and has excellent tracking resistance is preferable. As such an insulating material, for example, a heat-resistant polyamide (semi-aromatic polyamide), a heat-resistant nylon (e.g., PA9T and PA6T), or PPS can be used.

Alternatively, the insulating material forming the bobbin is preferably thermoplastic resin. Examples of thermoplastic resin include, in addition to general-purpose plastics, super engineering plastics. Examples of super engineering plastics include PEEK, PBN, PBI, PPS, LCP, PAI, PTFE, PSF, PCTFE, PAR, PI, PES, PFA, ETFE, and PVDF.

Among these, PAI, PPS, PEEK, and the like having a heat-resistant temperature of 240° C. or higher can be suitably used, and LCP and the like having a heat-resistant temperature of 280° C. or higher can also be suitably used. Because these materials are highly impact-resistant, tough, and readily subject to cut processing, they can be suitably used for fine processing, such as joining of bobbins.

The bobbin 60 includes a first bobbin 60a and a second bobbin 60b. The second bobbin 60b has the same shape as the first bobbin 60a but may have a shape slightly different from the first bobbin 60a. Description of the first bobbin 60a below applies to the second bobbin 60b to the extent to which the first and second bobbins have identical properties.

As illustrated in FIG. 8, a first abutting portion 61a of the first bobbin 60a is inserted in a first abutting portion 61b of the second bobbin 60b. A second abutting portion 62b of the second bobbin 60b is inserted in a second abutting portion 62a of the first bobbin 60a. The first bobbin 60a and the second bobbin 60b are connected at the first abutting portions 61a and 61b of the first cylindrical portions 61 and the second abutting portions 62a and 62b of the second cylindrical portions 62. The first abutting portions 61a and 61b are disposed at a location shifted along the X-axis direction from a location of the second abutting portions 62a and 62b. The second abutting portions 62a and 62b are disposed at a location closer to the flange portion 63a than the first abutting portions 61a and 61b along the X-axis direction.

As illustrated in FIG. 8, the flange portion 63a includes a flange inner end wall 64a covering the inner end surface 14a and a flange side wall 65a covering the side surfaces 16a, 17a, 18a, and 19a of the connecting portion 13a. To the flange portion 63a, the terminal block 50a separate from the bobbin 60 is attached. The flange portion 63b includes a flange inner end wall 64b covering the inner end surface 14b and a flange side wall 65b covering the side surfaces 16b, 17b, 18b, and 19b of the connecting portion 13b.

To the flange portion 63b, the terminal block 50b separate from the bobbin 60 is attached. As illustrated in FIG. 7, the terminal blocks 50a and 50b may be anchored to the core 10 using the adhesive 70. Disposing the adhesive 70 where respective top surfaces 53a and 53b (described later) and the outer end surfaces 15a and 15b meet enables the terminal blocks 50a and 50b, the bobbin 60, and the core 10 to be readily anchored and a creepage distance between the core 10 and the first and second terminals (41a, 41b, 42a, and 42b) to be improved.

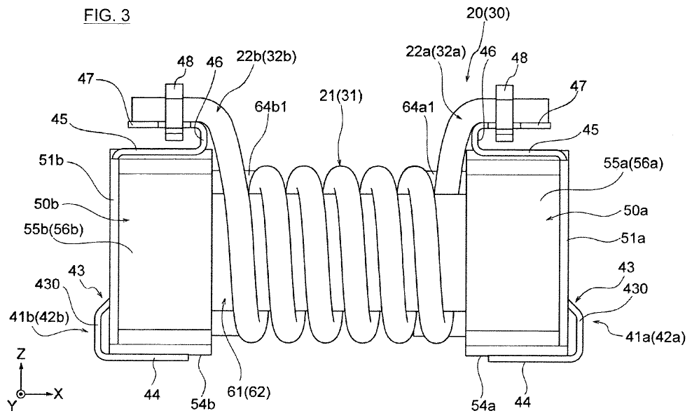

The terminal block 50a includes a terminal block outer end wall 51a covering the outer end surface 15a and a terminal block side wall 52a covering the flange side wall 65a. The terminal block 50b includes a terminal block outer end wall 51b covering the outer end surface 15b and a terminal block side wall 52b covering the flange side wall 65b. As illustrated in FIG. 3, the first terminal 41a and the second terminal 42a are anchored to the terminal block 50a. The first terminal 41b and the second terminal 42b are anchored to the terminal block 50b.

The terminal blocks 50a and 50b may be made from the insulating material mentioned as example materials of the bobbin 60 but may be made from a different insulating material. The insulating material of the terminal blocks 50a and 50b is not limited but is preferably an insulating material having excellent heat resistance up to a high temperature of 260° C. or higher. As the insulating material of the terminal blocks 50a and 50b, for example, LCP can be used.

Alternatively, the material of the terminal blocks 50a and 50b is preferably thermosetting resin. Examples of thermosetting resin include UP, UF, MF, PUR, SI, PL-FLE, PL-PEM, and EP-EG-FRP. The thermosetting resin can be selected from various thermosetting resin according to required characteristics. Examples of thermosetting resin include phenol resin, urea resin, and epoxy resin in terms of strength under high temperature; urea resin and epoxy resin in terms of electromagnetic characteristics; and melamine resin in terms of flame retardancy.

Preferably, in the present embodiment, the terminal blocks 50a and 50b are made from thermosetting resin, and the bobbin 60 is made from thermoplastic resin. Such a structure enables the coil device to have excellent creep properties (e.g., folding and distortion), high mechanical strength, and high impact resistance. Such a structure also enables effective prevention of cracks and chips at joints between the bobbin 60 and the terminal blocks 50a and 50b.

The first terminals 41a and 41b and the second terminals 42a and 42b are made from metal, such as tough pitch copper, phosphor bronze, brass, iron, nickel, nickel alloys, and stainless steel. The first terminals 41a and 41b and the second terminals 42a and 42b can be integrally molded by, for example, punch-pressing and folding a conductive metal plate. Outer surfaces of the first terminals 41a and 41b and the second terminals 42a and 42b are preferably provided with a plating film of tin, an alloy containing tin, or the like as a solder adhesion reinforcement layer.

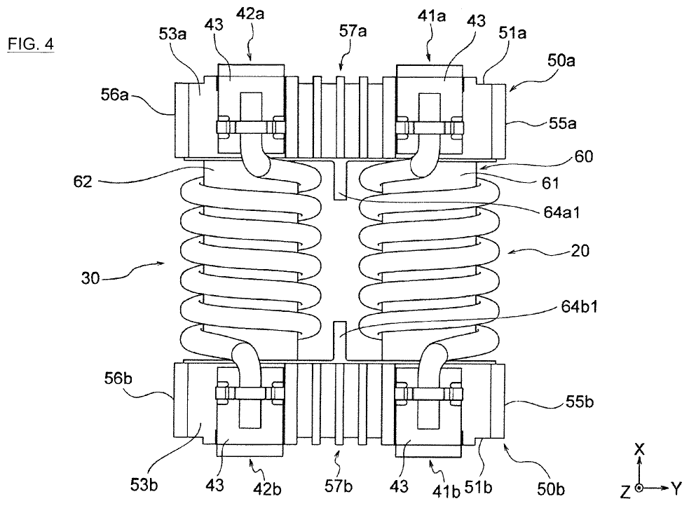

As illustrated in FIG. 4, the terminal block 50a includes a terminal block uneven portion 57a being elevated and depressed along the Y-axis between the first terminal 41a and the second terminal 42a. Likewise, the terminal block 50b includes a terminal block uneven portion 57b being elevated and depressed along the Y-axis between the first terminal 41b and the second terminal 42b. In particular, the terminal block uneven portions 57a and 57b at the terminal block outer end walls 51a and 51b are provided so that the terminal block uneven portions 57a and 57b can fit to cover uneven portions 106 of the cover 100 described later.

As illustrated in FIG. 3, each of the first terminals 41a and 41b and the second terminals 42a and 42b includes a terminal main piece 43, a mounting piece 44, a base piece 45, a standing piece 46, and a connecting piece 47. The first terminal 41a and the second terminal 42a are anchored to the terminal block outer end wall 51a. The first terminal 41b and the second terminal 42b are anchored to the terminal block outer end wall 51b. The respective mounting pieces 44 of the first terminals 41a and 41b and the second terminals 42a and 42b are disposed on the same XY plane.

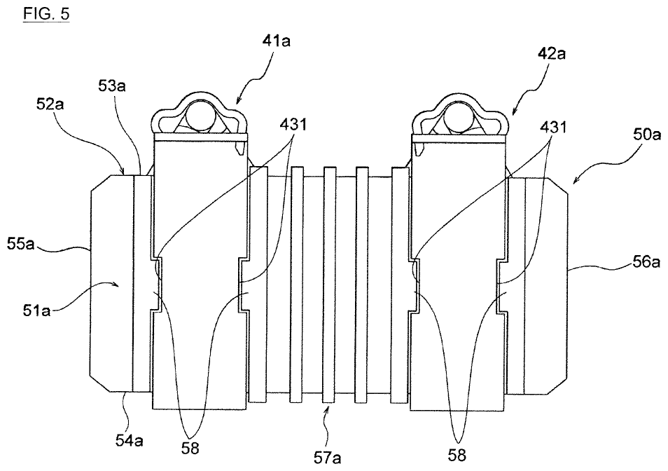

As illustrated in FIG. 5, each terminal main piece 43 has engagement grooves 431 engaging with engagement projecting portions 58 of the corresponding terminal block outer end wall to position the terminal. Any method may be used for anchoring the terminal to the terminal block. The terminal may be anchored to the terminal block by press-fitting the terminal to the terminal block or by insert molding. Alternatively, the terminal main piece 43 may be anchored to the corresponding terminal block outer end wall using an adhesive. As illustrated in FIG. 7, the terminal main piece 43 may include a protruding portion 430 protruding away from the terminal block outer end wall.

Each mounting piece 44 is disposed substantially parallel to a bottom surface 54a or a bottom surface 54b of the corresponding terminal block side wall, with a predetermined space W1 from the bottom surface 54a or 54b. Each base piece 45 is disposed substantially parallel to the top surface 53a or the top surface 53b of the corresponding terminal block side wall, with a predetermined space W2 from the top surface 53a or 53b. The predetermined spaces W1 and W2 are not limited but are preferably at least 0 or more preferably at least 0.1 times the thickness of the metal plate constituting the terminal.

As illustrated in FIG. 3, each standing piece 46 extends away from the terminal block 50a or 50b along the Z-axis from the corresponding base piece 45 and is connected to the corresponding connecting piece 47, which connects to a corresponding one of lead portions 22a, 22b, 32a, and 32b of the first wire 20 and the second wire 30. The connecting piece 47 extends away from the flange inner end wall 64a or 64b. Also, the connecting piece 47 includes a crimping piece 48 for anchoring the corresponding one of the lead portions 22a, 22b, 32a, and 32b of the first wire 20 and the second wire 30.

As illustrated in FIGS. 3 and 4, the first wire 20 includes a coil portion 21 wound around the first cylindrical portions 61 and the lead portions 22a and 22b drawn from the coil portion 21. The lead portion 22a is connected to the first terminal 41a. The lead portion 22b is connected to the first terminal 41b.

As illustrated in FIGS. 3 and 4, the second wire 30 includes a coil portion 31 wound around the second cylindrical portions 62 and the lead portions 32a and 32b drawn from the coil portion 31. The lead portion 32a is connected to the second terminal 42a. The lead portion 32b is connected to the second terminal 42b.

The lead portions 22a, 22b, 32a, and 32b of the wires are connected to the respective connecting pieces 47 and/or crimping pieces 48 using methods such as laser welding, soldering, thermocompression bonding, arc welding, and resistance welding.

The first wire 20 and the second wire 30 are not limited. As these wires, for example, conductive core wires (e.g., rectangular wires, round wires, stranded wires, litz wires, and braided wires) made of copper or the like or wires in which such conductive core wires are insulation coated can be used. The first wire 20 and the second wire 30 may have any diameter D and may have an outer diameter that is about 1.2 to 5 times the plate thickness of the first terminals 41a and 41b and the second terminals 42a and 42b. The diameter D of the first wire 20 and the second wire 30 may be, for example, 0.9 to 2.7 mm.

As illustrated in FIG. 8, between the first wire 20 and the second wire 30, a flange partition portion 64al provided at the flange inner end wall 64a and a flange partition portion 64b1 provided at the flange inner end wall 64b are disposed. The flange partition portions 64al and 64b1 fit to a cover partition portion 104 of the cover 100 to isolate the coil portion 21 of the first wire 20 from the coil portion 31 of the second wire 30.

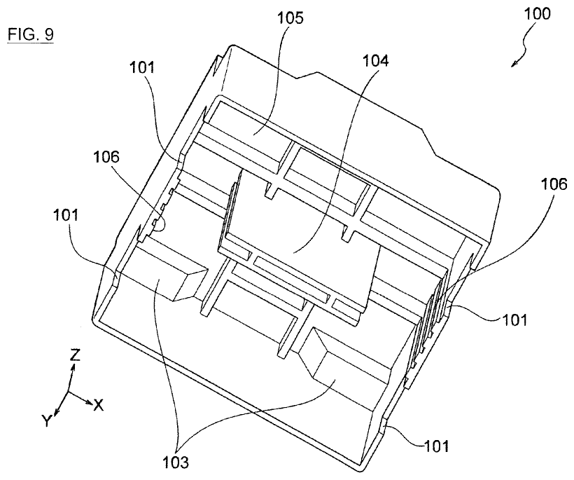

As illustrated in FIG. 7, the cover 100 includes a top panel 105 covering the first wire 20 and the second wire 30 from above in the Z-axis direction. The cover 100 is attached to the terminal blocks 50a and 50b. For attachment of the cover 100 to the terminal blocks 50a and 50b, attachment surfaces 103 (see FIG. 9) of the cover 100 may be anchored to the top surfaces 53a and 53b of the terminal blocks 50a and 50b using an adhesive or the like, or a fitting structure may be adopted to enable anchoring.

The cover 100 includes an outer wall 107 covering the terminal block outer end walls 51a and 51b and side surfaces 55a, 55b, 56a, and 56b of the terminal block side walls 52a and 52b. As illustrated in FIG. 9, the outer wall 107 covering the terminal block outer end walls 51a and 51b has cut-out portions 101. As illustrated in FIG. 1, the protruding portions 430 of the terminals protrude from the cut-out portions 101. When the coil device 1 is mounted on a circuit board or the like, a solder fillet can be formed at the protruding portions 430.

As illustrated in FIG. 9, the outer wall 107 covering the terminal block outer end walls 51a and 51b includes the cover uneven portions 106 being elevated and depressed along the Y-axis. As illustrated in FIG. 8, the cover uneven portions 106 are formed to fit to the terminal block uneven portions 57a and 57b.

In such a manner, in the present embodiment, providing the terminal block uneven portions 57a and 57b increases the creepage distance between the first terminals 41a and 41b and the second terminals 42a and 42b. Further, by fitting the cover uneven portions 106 to the terminal block uneven portions 57a and 57b, the cover 100 and the terminal blocks 50a and 50b are firmly anchored, and insulation between the first terminals 41a and 41b and the second terminals 42a and 42b is further improved.

The cover 100 may be made from the insulating material mentioned as example materials of the bobbin 60 but may be made from a different insulating material. For example, as the insulating material of the cover 100, LCP can be used.

In the present embodiment, as illustrated in FIG. 1, with the top panel 105 and the outer wall 107, the cover 100 can protect the first terminals 41a and 41b, the second terminals 42a and 42b, the first wire 20, and the second wire 30 and prevent electrical leakage from the first terminals 41a and 41b, the second terminals 42a and 42b, the first wire 20, and the second wire 30 to other parts. Also, suctioning of the flat top panel 105 of the cover 100 using a suction nozzle or the like enables easy transport of the coil device 1.

As illustrated in FIG. 7, the core 10 is accommodated in the bobbin 60. The first wound portions 11 of the core 10 are covered by the first cylindrical portions 61 of the bobbin 60, and the second wound portions 12 of the core 10 are covered by the second cylindrical portions 62 of the bobbin 60. The connecting portions 13a and 13b of the core 10 are completely covered by the flange portions 63a and 63b of the bobbin 60 and the terminal blocks 50a and 50b. Thus, the core 10 can be insulated from the first wire 20 and the second wire 30.

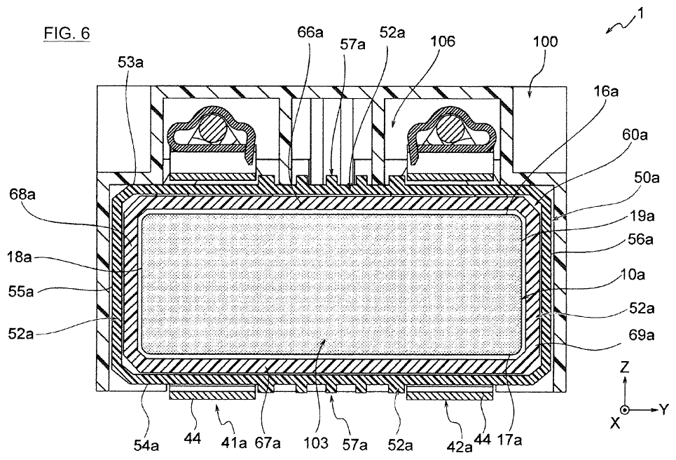

As illustrated in FIG. 6, the flange side walls 65a and 65b of the bobbin 60 cover the side surfaces 16a, 17a, 18a, 19a, 16b, 17b, 18b, and 19b of the connecting portions 13a and 13b. Further, the flange side walls 65a and 65b of the bobbin 60 are covered by the terminal block side walls 52a and 52b. As the connecting portions 13a and 13b of the core 10 are dually covered in such a manner, the creepage distance between the first and second wires (20 and 30) and the core 10 is readily enhanced. Also, the creepage distance between the terminal main pieces 43, where the first terminals 41a and 41b and the second terminals 42a and 42b come in contact with the terminal blocks 50a and 50b, and the core 10 is improved. Thus, in the coil device 1, insulation is more effectively ensured, which can support recently demanded uses involving high voltages (e.g., 800 kV or higher).

As illustrated in FIG. 3, the first terminals 41a and 41b and the second terminals 42a and 42b are anchored to the terminal blocks 50a and 50b, and the mounting pieces 44 of the first terminals 41a and 41b and the second terminals 42a and 42b are disposed on the same XY plane. Thus, the coil device 1 is readily surface-mounted on a circuit board or the like.

As illustrated in FIG. 7, each mounting piece 44 is disposed substantially parallel to the bottom surface 54a or the bottom surface 54 of the corresponding terminal block side wall, with the predetermined space W1 from the bottom surface 54a or 54b. Each base piece 45 is disposed substantially parallel to the top surface 53a or the top surface 53b of the corresponding terminal block side wall, with the predetermined space W2 from the top surface 53a or 53b. Such a structure further improves the creepage distance between the first and second terminals (41a, 41b, 42a, and 42b) and the core 10. Also, the predetermined spaces between the first and second terminals (41a, 41b, 42a, and 42b) and the terminal blocks (50a and 50b) in the Z-axis direction increase strength of the coil device 1 after being surface-mounted.

As illustrated in FIG. 8, the first abutting portions 61a and 61b are disposed at the location shifted along the X-axis direction from the location of the second abutting portions 62a and 62b. Difference between the locations of the respective abutting portions of the cylindrical portions 61 and 62 enables mitigation of influence of stress generated by deformation of the circuit board or the like where the coil device 1 is mounted. This increases strength of the coil device 1 itself and further increases the strength of the coil device 1 after being surface-mounted.

As illustrated in FIG. 2, the opposing surfaces 11a, 11b, 12a, and 12b of the first core 10a and the second core 10b are disposed at the location shifted from the location of the first abutting portions 61a and 61b and the location of the second abutting portions 62a and 62b. Difference between the locations of the opposing surfaces 11a, 11b, 12a, and 12b of the core 10 and the abutting portions 61a, 61b, 62a, and 62b of the cylindrical portions 61 and 62 further increases the strength of the coil device 1.

Variously modified forms, shapes, and the like within the scope of the claims are included in the technical scope of the above-mentioned embodiment.

Although each of the first terminals 41a and 41b and the second terminals 42a and 42b has an S shape including the terminal main piece 43, the mounting piece 44, the base piece 45, the standing piece 46, and the connecting piece 47 in the above-mentioned embodiment, the terminals may have different shapes. For example, the first terminals 41a and 41b and the second terminals 42a and 42b may have a U shape that does not include a standing piece 46 or a connecting piece 47.

### REFERENCE NUMERALS

1 . . . coil device
10 . . . core
10a . . . first core
10b . . . second core
11 . . . first wound portion
11a, 11b . . . opposing surface
12 . . . second wound portion
12a, 12b . . . opposing surface
13a, 13b . . . connecting portion
14a, 14b . . . inner end surface
15a, 15b . . . outer end surface
16a, 16b . . . first side surface
17a, 17b . . . second side surface
18a, 18b . . . third side surface
19a, 19b . . . fourth side surface
20 . . . first wire
21 . . . coil portion
22a, 22b . . . lead portion
30 . . . second wire
31 . . . coil portion
32a, 32b . . . lead portion
41a, 41b . . . first terminal
42a, 42b . . . second terminal
43 . . . terminal main piece
430 . . . protruding portion
431 . . . engagement groove
44 . . . mounting piece
45 . . . base piece
46 . . . standing piece
47 . . . connecting piece
48 . . . crimping piece
50a, 50b . . . terminal block
51a, 51b . . . terminal block outer end wall
52a, 52b . . . terminal block side wall
53a, 53b . . . top surface
54a, 54b . . . bottom surface
55a, 55b, 56a, 56b . . . side surface
57a, 57b . . . terminal block uneven portion
58 . . . engagement projecting portion
60 . . . bobbin
60a . . . first bobbin
60b . . . second bobbin
61 . . . first cylindrical portion
61a, 61b . . . first abutting portion
62 . . . second cylindrical portion
62a, 62b . . . second abutting portion
63a, 63b . . . flange portion
64a, 64b . . . flange inner end wall
64a1, 64b1 . . . flange partition portion
65a, 65b . . . flange side wall
70 . . . adhesive
100 . . . cover
101 . . . cut-out portion
103 . . . attachment surface
104 . . . cover partition portion
105 . . . top panel
106 . . . cover uneven portion
107 . . . outer wall

What is claimed is:

1. A coil device comprising:
a first wire connected to a first terminal;
a second wire connected to a second terminal;
a terminal block anchoring the first terminal and the second terminal;
a bobbin including a first cylindrical portion wound around with the first wire and extending along a first axis, a second cylindrical portion wound around with the second wire and extending along the first axis, and a flange portion connecting the first cylindrical portion and the second cylindrical portion; and
a core accommodated in the bobbin,
wherein the terminal block at least partly covers the flange portion of the bobbin.

2. The coil device according to claim 1, wherein
the bobbin comprises a first bobbin and a second bobbin;
the first bobbin and the second bobbin are connected at a first abutting portion of the first cylindrical portion and a second abutting portion of the second cylindrical portion; and
the first abutting portion is disposed at a location shifted along the first axis from a location of the second abutting portion.

3. The coil device according to claim 2, wherein
the core comprises a first core and a second core;
the first core and the second core comprise respective opposing surfaces opposing each other along the first axis; and
the opposing surfaces are disposed at a location shifted from the location of the first abutting portion and the location of the second abutting portion.

4. The coil device according to claim 1, wherein
the core comprises a first wound portion accommodated in the first cylindrical portion, a second wound portion accommodated in the second cylindrical portion, and a connecting portion connecting the first wound portion and the second wound portion;
the connecting portion comprises an inner end surface connected to respective proximal ends of the first wound portion and the second wound portion, an outer end surface opposite the inner end surface along the first axis, and a side surface connecting the inner end surface and the outer end surface;
the flange portion comprises a flange inner end wall covering the inner end surface and a flange side wall covering the side surface; and
the terminal block comprises a terminal block outer end wall covering the outer end surface and a terminal block side wall covering the flange side wall.

5. The coil device according to claim 4, wherein
the first terminal and the second terminal each comprise a terminal main piece anchored to the terminal block outer end wall and a base piece disposed over a top surface of the terminal block side wall; and
the base piece is disposed with a predetermined space from the top surface.

6. The coil device according to claim 4, wherein the first terminal and the second terminal each comprise a mounting piece disposed with a predetermined space from a bottom surface of the terminal block side wall.

7. The coil device according to claim 4, wherein the flange inner end wall comprises a flange partition portion between the first cylindrical portion and the second cylindrical portion so that the flange partition portion enhances a creepage distance between the first wire and the second wire.

8. The coil device according to claim 1, wherein the terminal block comprises a terminal block uneven portion between the first terminal and the second terminal so that the terminal block uneven portion enhances a creepage distance between the first terminal and the second terminal.

9. The coil device according to claim 1 further comprising a cover attached to the terminal block so as to cover the first wire and the second wire from above.

10. The coil device according to claim 9, wherein
the flange portion comprises a flange inner end wall covering the inner end surface;
the flange inner end wall comprises a flange partition portion between the first wire and the second wire; and
the cover comprises a cover partition portion fitted to the flange partition portion to isolate a coil portion of the first wire from a coil portion of the second wire.

11. The coil device according to claim 1, wherein
the terminal block is made from a thermosetting resin; and
the bobbin is made from a thermoplastic resin.
